(19) United States
(12) Patent Application Publication
(10) Pub. No.: US 2024/0015194 A1
(43) Pub. Date: Jan. 11, 2024

(54) COLLABORATIVE CHAT MESSAGING FOR VIRTUAL MEETINGS

(71) Applicant: Zoom Video Communications, Inc., San Jose, CA (US)

(72) Inventors: William Thomas Bernabe, Northborough, MA (US); Benjamin Joseph DeStephen, Hilliard, OH (US)

(21) Appl. No.: 17/859,350

(22) Filed: Jul. 7, 2022

(51) Int. Cl. H04L 65/403

(52) U.S. Cl. CPC H04L 65/403

(57) ABSTRACT

Systems and methods for collaborative chat messaging are provided herein. In an example, a system having a non-transitory computer-readable medium, a communications interface, and a processor is provided. The processor may execute instructions to establish a virtual meeting having a plurality of participants, each participant of the plurality of participants exchanging one or more audio streams via the virtual meeting. The processor may also execute instructions to transmit a collaborative message request to the plurality of participants, receive one or more collaborative message responses from each participant of a subset of the plurality of participants, and provide, to a first client device, the one or more collaborative message responses. The processor may also execute instructions to receive, from the first client device, an indication to release the one or more collaborative message responses and transmit, to the plurality of participants, the one or more collaborative message responses.

### FIELD

The present application generally relates to videoconferences and more particularly relates to systems and methods for collaborative chat messaging for virtual meetings.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1, 2, and 3 show example systems for providing collaborative chat messaging during a virtual meeting, according to an embodiment herein;

FIG. 4 shows a graphical user interface during a virtual meeting, according to an embodiment herein;

FIG. 5 illustrates an example chat channel, according to an embodiment herein;

FIG. 6 illustrates an example chat channel having a collaborative message request therein, according to an embodiment herein;

FIG. 7 illustrates an example collaborative message response review prompt, according to an embodiment herein;

FIG. 8 illustrates an example chat channel with released collaborative message responses therein, according to an embodiment herein;

FIG. 9 illustrates an exemplary method for providing collaborative chat messaging during a virtual meeting, according to an embodiment herein; and

FIG. 10 shows an example computing device suitable for providing collaborative chat messaging during a virtual meeting, according to this disclosure.

### DETAILED DESCRIPTION

Examples are described herein in the context of systems and methods for providing collaborative chat messaging during a virtual meeting. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Video conference providers can enable people to interact with each other using their own computers (or “client devices”) with both video and audio in a variety of settings, such as in one-on-one conversations, group meetings, and webinars. While each of these types of settings can allow people to interact with each other, they can differ in character. For example, one-on-one conversations include only two people and may involve only a small amount of data being transmitted between the two client devices. Group meetings may involve a larger number of people all interacting with each other. In contrast, webinars typically involve a group of people that are attending to hear presentations from one or more presenters. Thus, in a webinar, interaction tends to be mostly one-way: from the presenter(s) to the audience. In addition, webinars can have very large numbers of participants, potentially numbering in the thousands or tens of thousands.

As the popularity of virtual meetings to replace conventional, in-person meetings, continues to rise, so too does the need for collaboration tools. Most virtual meetings include various collaboration tools, such as chat messaging and polls. Both of these collaboration tools can be used to elicit responses from meeting participants. For example, a host may ask a question via chat message to elicit a response from meeting participants or a host may initiate a poll to elicit responses from meeting participants. For a poll, the host is limited to pre-defined responses and polling does not allow free-formed responses from participants. And chat messaging does not allow participants to respond to a question until all participants have responded. Instead, hosts or moderators often request participants to hold their responses until a specified time so that all the responses can be shared at the same time. Thus, if a participant types his or her response into the chat messenger, the participant must wait until the cue from the host to respond and is unable to utilize the chat messenger until the response is shared. Accordingly, current collaboration tools do not allow for collaborative message responses from meeting participants.

To provide for collaborative message responses, systems and methods for collaborative chat messaging is provided herein. The collaborative message functionality, which is also referred to as “chatterfall functionality” herein, provides a host or co-host the ability to request collaborative message responses from participants during a virtual meeting. Once a host requests a collaborative message, meeting participants can enter and send their responses. Each collaborative message response is transmitted to the host, who can review, edit, and even reject a response. When the host determines enough collaborative message responses have been received or a time frame for responding to the collaborative message responses has eclipsed, then the collaborative meeting responses may be released to the meeting participants. The collaborative meeting responses may be released simultaneously so that they are received by the meeting participants together.

The collaborative message functionality provided herein enables meeting participants to see collaborative feedback and thoughts simultaneously. This can prevent another participant's input from influencing a participant's response. Additionally, the collaborative message functionality can allow a meeting host, co-host, or moderator the structure to allow feedback simultaneously and at a desired timing within the virtual meeting. Moreover, the collaborative message functionality allows a host or co-host to moderate the participants' responses prior to publishing them on a chat channel.

In an example scenario, a host may make a collaborative message request to the participants at the onset of a virtual meeting. The participants may respond to the collaborative message request upon receipt of the request but the host may hold releasing the collaborative message responses until the end of the meeting. For example, the host may use the initial collaborative message request to gather a sense of a knowledge level of the participants at the beginning of the meeting. The host may then share the collaborative message responses at the end of the meeting to show the participants how much the participants learned during the virtual meeting. The above scenario may be particularly advantageous in an educational or academic setting.

The collaborative messaging functionality may also help a host or co-host moderate responses from meeting participants. For example, if the collaborative messaging functionality is employed during a town hall meeting, the host may be able to review the collaborative message responses before sharing the responses with the meeting participants. If the host determines that a collaborative message response is inappropriate, the host may remove the collaborative message response from the response group before releasing the responses to the meeting participants. In some embodiments, the host may use the inappropriate collaborative message response to take further action with respect to the sending participant by, for example, removing that participant's ability to interact or participate in the virtual meeting.

The collaborative messaging functionality may also be used to gather anonymous feedback from meeting participants. For example, the host may elicit feedback on participants' understanding of a topic that was just covered. As participants who don't fully understand the topic may be embarrassed to admit they don't understand, the collaborative messaging functionality may allow for anonymous responses. For example, in an academic setting, a student may be embarrassed to say that he or she didn't fully understand a topic that was just taught. By using the collaborative message functionality, the host (e.g., teacher) may be able to evaluate participants feedback and participants may be comfortable to answer the request honestly.

This illustrative example is given to introduce the reader to the general subject matter discussed herein and the disclosure is not limited to this example. The following sections describe various additional non-limiting examples and examples of systems and methods for collaborative chat messaging for virtual meeting.

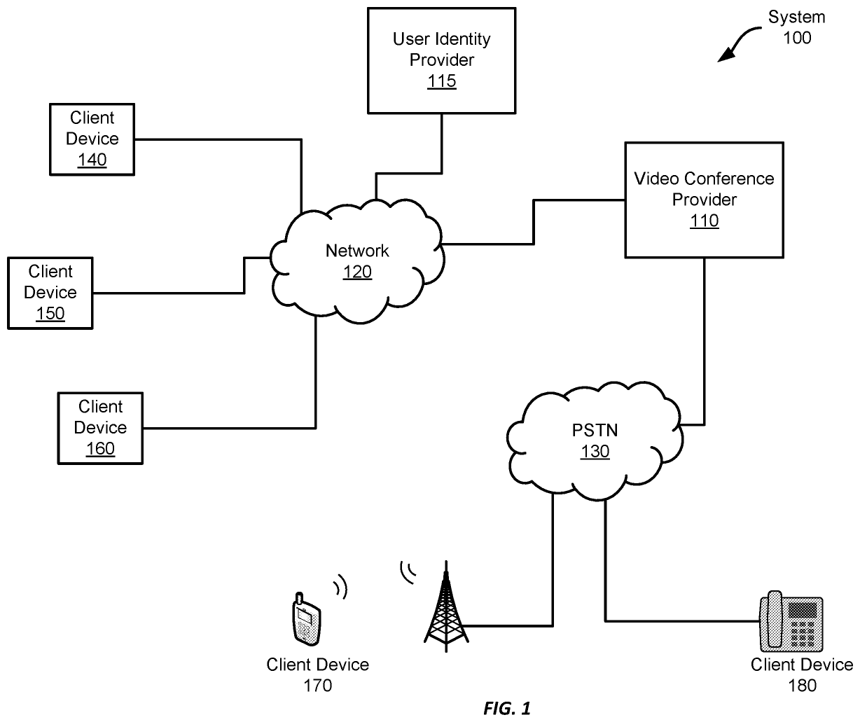

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 110 can be located within a private network to provide video conferencing services to devices within the private network, or it can be connected to a public network, e.g., the interne, so it may be accessed by anyone. Some examples may even provide a hybrid model in which a video conference provider 110 may supply components to enable a private organization to host private internal video conferences or to connect its system to the video conference provider 110 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

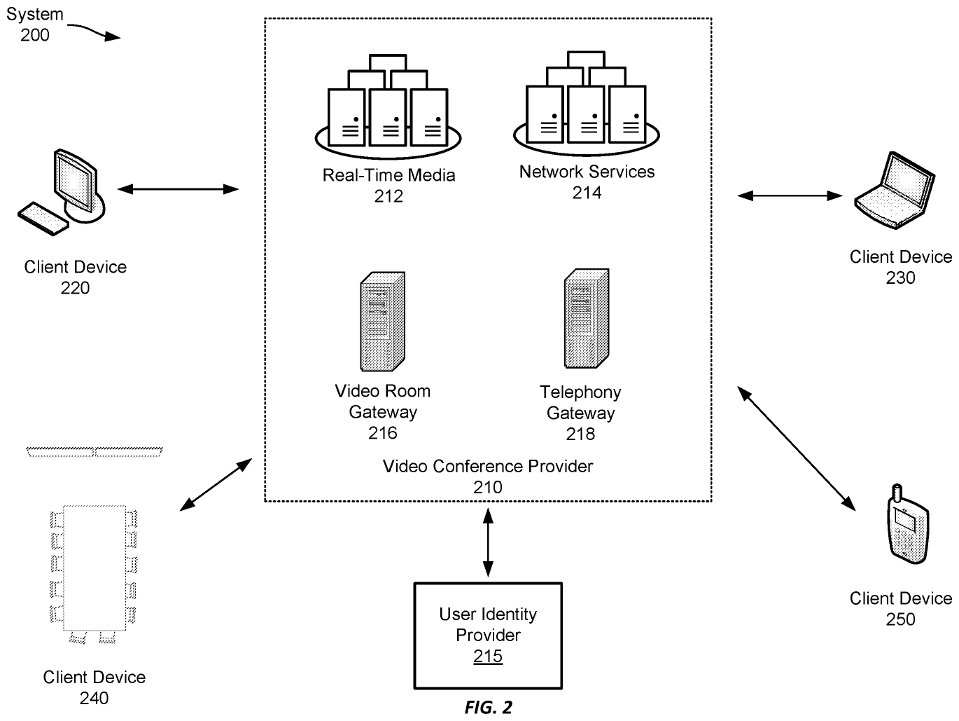

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), interne protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can making conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different Examples of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

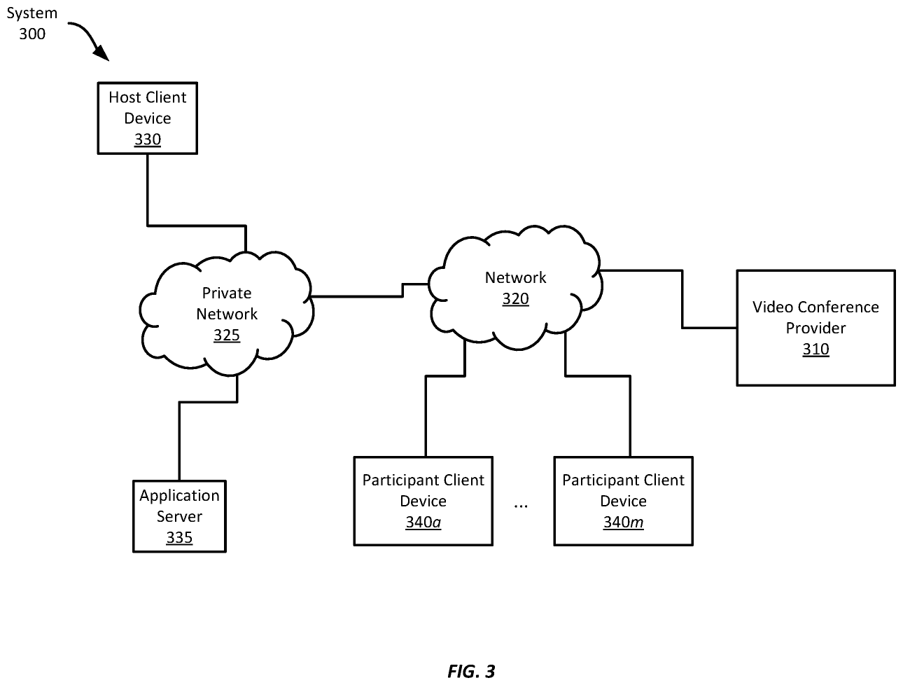

Referring now to FIG. 3, FIG. 3 shows an example system 300 for providing collaborative messaging during a virtual meeting. In this example, a video conference provider 310 provides video conference services to multiple different client devices 330 and 340a-m, generally as described above with respect to FIGS. 1 and 2. In this example, the client devices 330 and 340a-m participate in a meeting hosted by the video conference provider 310. Client devices 340a-m connect to the video conference provider 310 over a public network 320, e.g., the internet; however, host client device 330 participates from within a private network 325, such as from their office at work. In addition to the host client device 330, an application server 335 is connected to the private network and makes various business applications available to the host client device 330. In different examples, these business applications may vary; however, in this example, the application server 335 provides applications to access business databases and files. To access these various resources, the host client device 330 has different client applications installed on it and may also have web applications accessible via a web browser, which may be stored as bookmarks in the web browser.

To start a meeting, the host client device 330 connects to the video conference provider 310 and begins a virtual meeting (“meeting”) at the video conference provider 310, such as by beginning a scheduled meeting, generally as described above with respect to FIGS. 1 and 2. The video conference provider 310 may create and manage the meeting as discussed above.

Once the virtual meeting is started, participants may be able to interact with other participants and see their respective names, such as in close proximity to other participants' video streams or in a list of participants visible in a graphical user interface (“GUI”). In some embodiments, the participants may only be able to see information, e.g., names or video feeds, from the host(s) of the meeting or certain select participants that will be engaged in discussions during the virtual meeting, such as panelists in a panel discussion. Still other limits may be imposed on the various participants, such as their ability to react to occurrences during the meeting, e.g., participants may be allowed to interact with their GUI to raise their hand to ask a question, but may not be allowed to provide any other feedback.

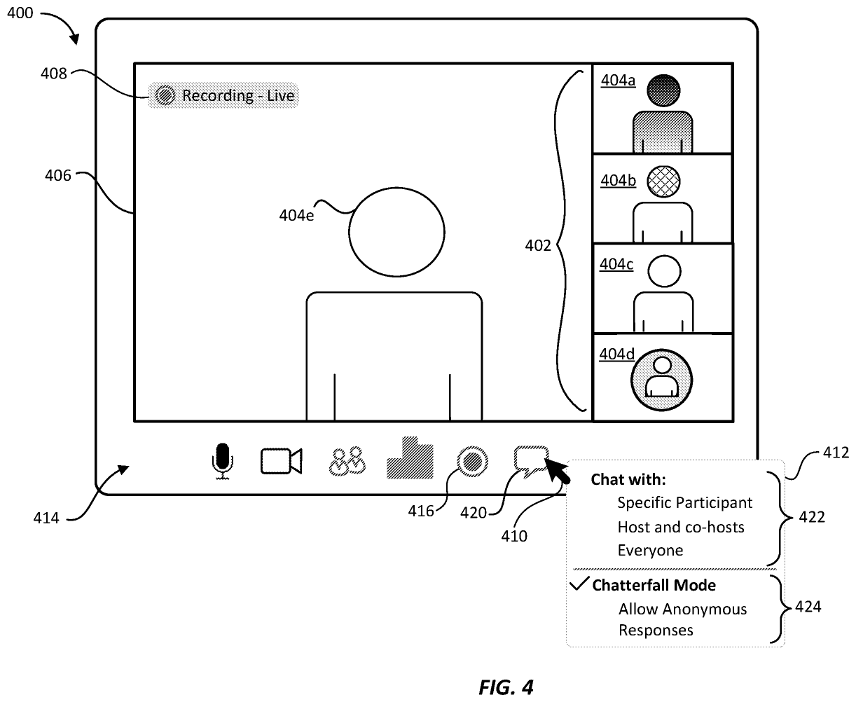

During the meeting the host client device 330, or a participant assigned by the host client device 330, such as a co-host, may transmit a collaborative message request. A collaborative message request may be a message requesting input or a response from some or all of the participants in the meeting. For example, the host client device 330 may send a collaborative message request to the participant client devices 340a-m via the video conference provider 310. Upon receipt of the collaborative message request, each of the participant client devices 340a-m may provide a collaborative message response. As will be discussed in greater detail below with respect to FIGS. 4-6, the collaborative message request may be transmitted via a chat channel hosted by the video conference provider 310 during the virtual meeting.

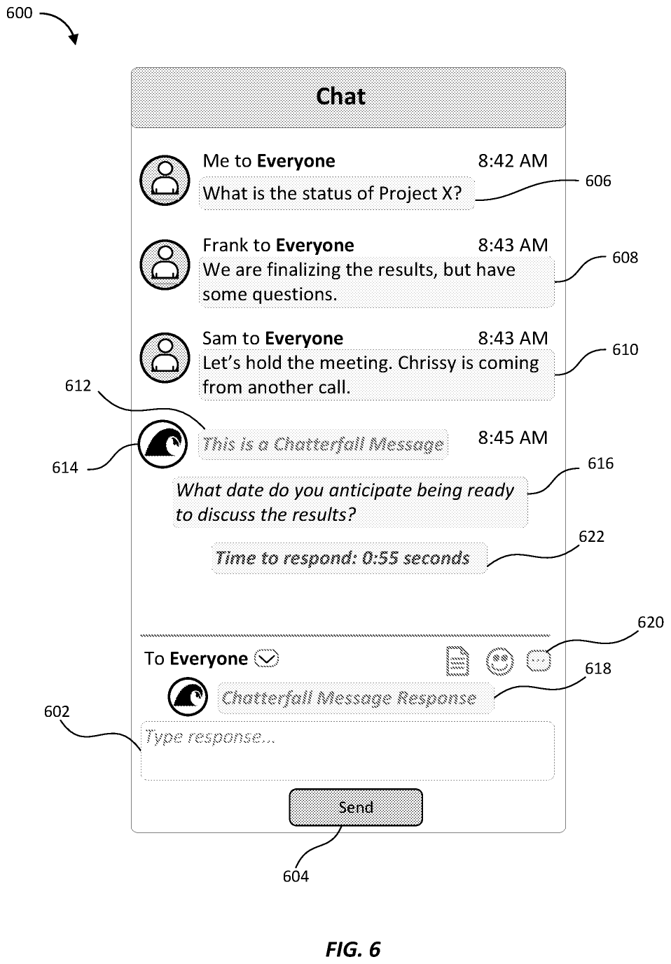

Unlike traditional messages, however, the collaborative meeting responses may not be shared with the participants client devices 340a-m until some or all of the responses are collected. For example, as responses are received from the participant client devices 340a-m, the responses may be cached by the video conference provider 310. As will be described in greater detail below, a host or co-host of the meeting, may review, edit, or remove responses prior to releasing the collaborative message responses. Upon releasing of the collaborative message responses, the collaborative message responses may be shared with some or all of the participant client devices 340a-m. Importantly, collaborative message responses are released simultaneously so that all of the responses are received at the same time by the participant client devices 340a-m. This prevents non-related messages from being interspersed within the collaborative message responses. The collaborative message request, response review, and release processes are described in greater detail below with respect to FIGS. 6-8.

Referring now to FIG. 4, a graphical user interface (GUI) 400 during a virtual meeting is provided, according to an embodiment herein. The GUI 400 may be presented to a participant or a host during a virtual meeting. The following figures and related components, such as GUI 400 of FIG. 4, will be described with respect to the system shown in FIG. 3, however, any suitable system according to this disclosure may be employed, such as those described in FIGS. 1 and 2.

In some embodiments, a GUI 400 is viewable to a participant of the video conference on the participant's device, for example the GUI 400 may be viewable to the meeting host on the host client device 330. Presentation of the GUI 400 on the participant's device may be in response to the initiation of the virtual meeting.

The GUI 400 may include a roster 402 of the participants 404a-e in the video conference. The roster 402 may include a video stream of some or all of the participants 404a-e. In other embodiments, the roster 402 may include a picture, image, representation, avatar or a listing of some or all of the participants 404a-e who have joined the virtual meeting. For example, as illustrated, the participant 404a may use a representation, the participant 404b may user an avatar, the participant 404c may user his or her video stream, and the participant 404d may use a picture on the roster 402. When a participant joins the video conference, the joining participant is added to the roster 402.

Once the virtual meeting is initiated, video and audio streams may be exchanged between the participants 404a-e. Display 406 may display the video stream of a currently speaking participant 404e. The audio stream from participant 404e may also be transmitted along with the video stream. In some embodiments, more than one participant may be speaking, and in such cases, the display 406 may include two or more windows providing the video streams from the speaking participants.

The GUI 400 may also include a dashboard 414 containing one or more action selections. For example, the dashboard 414 may include a recording selection 416 that allows a participant to record the streams of audio and video during the video conference. To initiate recording of the virtual meeting, a participant may select the recording selection 416. The recording selection 416 may transmit a recording request to the video conference provider 310, which may transmit a notification or request to the other meeting participants, as noted above. If the recording request is accepted, then the meeting may be recorded. Upon recording, an indication 408 may be provided to indicate to the participants 404a-e that they are being recorded. The indication 408 may be helpful for the participants 404a-e to know that their audio and video streams are being recorded.

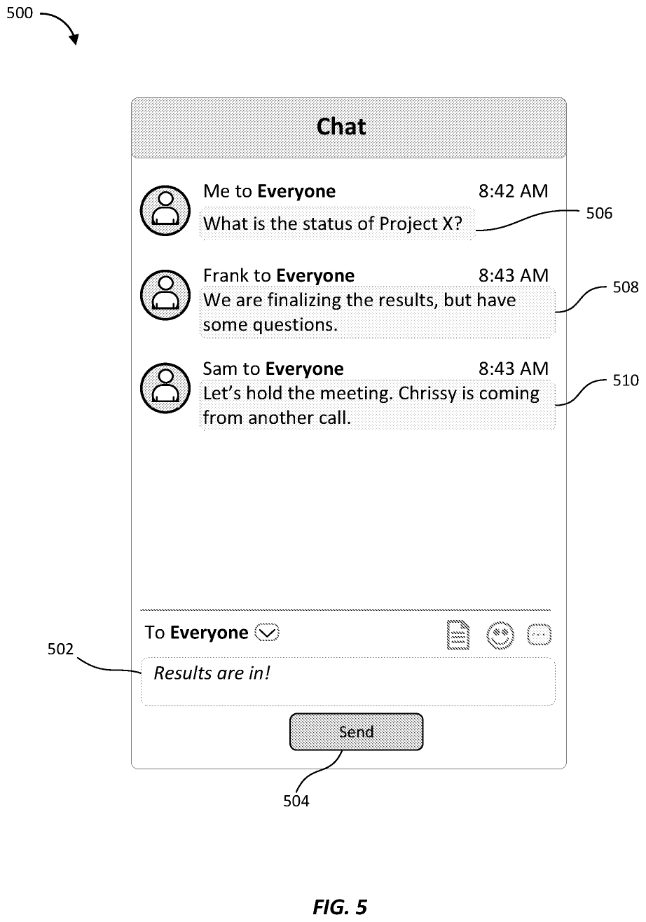

The dashboard 414 may also include a chat selection 420. The chat selection, when invoked, may open a chat channel between one or more participants within the virtual meeting. With reference to FIG. 5, an example chat channel 500 is provided, according to an embodiment herein. The following figures and related components, such as chat channel 500 of

FIG. 5, will be described with respect to the system shown in FIG. 4, however, any suitable system according to this disclosure may be employed, such as those described in FIGS. 1-3.

Upon selection of the chat selection 420 with cursor 410, the chat channel 500 may be initiated. As illustrated in FIG. 4, options 412 may be presented upon selection of the chat selection 420. For example, the options 412 may include options 422 for participants to open a chat channel with. If the host selects everyone from the options 422, then the chat channel 500 may be opened. The chat channel 500 may allow the host to exchange chat messages with all the participants (e.g., the participant client devices 340a-m) within the virtual meeting. The participants can also exchange messages within the chat channel 500 and everyone in the meeting can receive and view the chat message.

The ability of a participant to initiate the chat channel 500 and with whom the participant can initiate the chat channel 500 may depend on chat messaging settings for the virtual meeting. For example, an administrator or the host may determine chat messaging settings for a virtual meeting that may prohibit chat messaging during the virtual meeting or may limit with whom a participant can exchange chat messages with (e.g., the participant can only open the chat channel 500 with the host).

The chat channel 500 may represent a conventional chat channel in which participants can exchange chat messages. The chat channel 500 freely allows participants to input text, emojis, or share files via input field 502. After selection of the send button 504, the message entered into input field 502 may be transmitted to the participants in the chat channel 500. As shown, when a participant enters text into the input field 502, the participant must either hold the text in the input field 502, and therefore cannot exchange other chat messages via the chat channel 500, or the participant must select the send button 504. When the participant selects the send button 504, the text in the input field 502 is published on the chat channel 500 such that the other participants can view the chat message.

When a chat message is sent, the chat message is nearly instantaneously published on the chat channel 500. For example, chat messages 506, 508, and 510 are published on the chat channel 500 at the time the sending participant selects the send button 504. As shown, the chat message 506 is published at 8:42 AM, the chat message 508 is published at 8:43 AM, and the chat message 510 is published at 8:43 AM, each of these times corresponding to a time at which the participant selected the send button 504 on his or her device.

As noted above, collaborative messaging or chatterfall messaging can allow a participant to gather message responses from participants and then hold publishing the responses on the chat channel 500 until a desired time. For example, a participant, such as a host or co-host, may make a collaborative message request. The collaborative message request is typically a question or a message that elicits a response from one or more participants within the virtual meeting. Participants can respond to the collaborative message request via the input field 502 and select the send button 504 once the response is completed in the input field 502. Instead of publishing immediately on the chat channel 500, however, the collaborative message response is held until the requesting participant (e.g., host) releases the responses. Once the host releases the responses, the responses are then published on the chat channel 500. It should be understood that while the collaborative messaging is performed within the chat channel 500 for this embodiment, in other embodiments, the collaborative messaging may be performed in another channel that is separate from the chat channel 500. In still further embodiments, there may be more than one chat channel 500 or more than one collaborative messaging channels.

Returning now to FIG. 4, to make a collaborative message request, a participant may select the chatterfall mode 424 in the options 412. The chatterfall mode 424 may also include various options or settings for the chatterfall mode 424. As illustrated, the chatterfall mode 424 may include the option to allow anonymous responses. Other options for chatterfall mode 424 may include selections for recipients of the collaborative message request (not shown). For example, similar to the options 422, the chatterfall mode 424 may include options to specify the recipient of the collaborative message request, such as everyone (e.g., all participants in the virtual meeting) or a subset of the participants of the virtual meeting.

If the participant selects to allow anonymous responses, then any responses received by the requesting participant may not include any participant identification information. For example, if the anonymous response option is not selected, then a response may include the responding participant's name or some other identification information (e.g., handle name, email address). In the anonymous mode, however, the requesting participant may only receive the response without any sending information. Anonymous responses may also be allowed or disallowed by a meeting administrator or host. For example, the settings for the virtual meeting may not allow anonymous responses. In such cases, then option to allow anonymous responses in the chatterfall mode 424 may not be present on options 412.

Upon selecting the chatterfall mode 424, a chat channel may open. If the participant already has a chat channel open, such as the chat channel 500, then the chat channel may register the next chat message input into the input field 502 to be a collaborative message request. The requesting participant may input the collaborative message request into the input field 502 and select the send button 504. The collaborative message request may publish on the chat channel 500 as another chat message.

Referring now to FIG. 6, an example chat channel 600 having a collaborative message request therein is provided, according to an embodiment herein. The chat channel 600 may be same or similar to the chat channel 500. The following figures and related components, such as chat channel 600 of FIG. 6, will be described with respect to the systems shown in FIGS. 4-5, however, any suitable system according to this disclosure may be employed, such as those described in FIGS. 1-3.

As noted above, upon entering of the collaborative message request into the input field 502 and selecting the send button 504, the collaborative message request 616 may be published on the chat channel 600. The collaborative message request 616 may include an indication that the chat message is a collaborative message request. For example, a chatterfall symbol 614 or a notification 612 may be included along with the collaborative message request 616 to indicate the chatterfall mode of the chat message.

To respond to the collaborative message request 616, a participant may type a response into the input field 602. To indicate that the next response is a collaborative messenger response, an indication 618 may be provided. In some embodiments, after the collaborative message request 616 is published on the chat channel 600, the participant's next chat message into the input field 602 must be a collaborative message response. That is, the input field 602 may recognize the next chat message sent after a collaborative message request 616 is published as a collaborative message response. This may encourage participants to respond to the collaborative message request 616.

In other embodiments, participants may be able to select options 620 to change the type of response. That is, a participant could change the collaborative message response 618 to be normal a chat message so that he or she can continue a conversation on the chat channel 600. When the participant is ready to respond to the collaborative message request 616, the participant may select the options 620 to return to the collaborative message response to provide his or her response.

In some embodiments, there may be a time period 622 for which the participants can provide their collaborative message responses. For example, the participants may have one minute to respond to the collaborative message request 616. The time period 622 may be a timer that provides a countdown for participants to provide their collaborative message responses. In other embodiments, the host or requesting participant may manually close the time response window for responding to the collaborative message request 616. In such cases, the time period 622 may provide a warning that participants have a few seconds to respond to the collaborative message request 616. In some examples, the time period 622 may provide a notification that the response window is “closing soon.” After the response time period 622 eclipses, the time period 622 may be replaced with a notification that the “response window is closed” or a similar notification. Providing a time period 622 for responding to the collaborative message request 616 may encourage participants to respond or may facilitate receiving the collaborative message responses in a timely fashion to help move the virtual meeting forward.

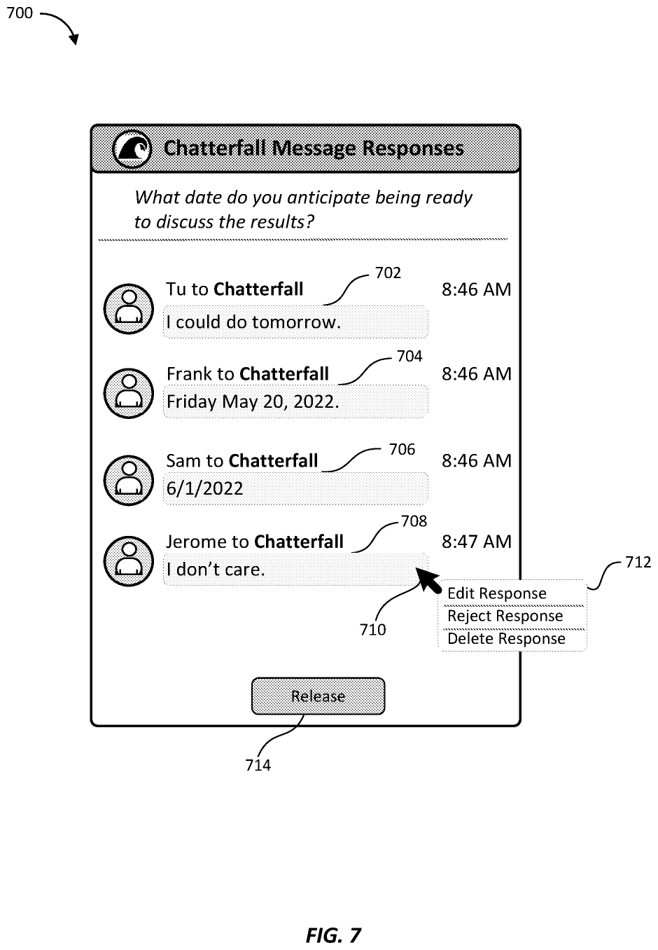

Once the time period 622 is eclipsed or the requesting participant has determined that the response window is closed (e.g., manually closing the response window or determining that enough responses have been received), the requesting participant may be able to review each of the collaborative message responses prior to releasing (e.g., publishing) them on the chat channel 600. Referring now to FIG. 7, an example collaborative message response review prompt 700 is provided, according to an embodiment herein. The following figures and related components, such as review prompt 700 of FIG. 7, will be described with respect to the systems shown in FIGS. 4-6, however, any suitable system according to this disclosure may be employed, such as those described in FIGS. 1-3.

The collaborative message response review prompt 700 may provide participant responses to the collaborative message request 616 as transmitted via the chat channel 600. For example, once a participant inputs his or her collaborative message response into the input field 602 and selects the send button 604, the response may be provided to the requesting participant via the prompt 700. In other embodiments, responses may only be provided to the requesting participant via the review prompt 700 when the time period 622 to respond has eclipsed.

The review prompt 700 may provide each of the collaborative message responses 702, 704, 706, and 708 to the requesting participant for review. As shown, the collaborative message responses 702-708 may include a variety of formats for the response. The different formats and responses that the collaborative message responses 702-708 allow is one advantage that the collaborative messaging functionality provides over conventional collaboration tools. Another advantage that the collaborative messaging functionality provides is the ability of the requesting participant to review, edit, and even delete responses prior to sharing the responses with the meeting participants.

If, upon review, the reviewing participant determines that a message response is inappropriate or inapplicable to the collaborative message request, then the reviewing participant may edit, reject, or delete the response. For example, the reviewing participant may determine that the collaborative message response 708 is an inappropriate response to the collaborative message request 616. The reviewing participant can select the response 708 with cursor 710 for options 712. The options 712 may include various actions that the reviewing participant can take with respect to the response 708. For example, the reviewing participant may want to rephrase the response 708 to a more positive response, such as “any date works for me.” In such case, the reviewing participant may select to edit the response 708.

In another scenario, the reviewing participant may delete the response 708 from the group of collaborative message responses (“response group”). If the response 708 is deleted from the response group, then when the reviewing participant releases the responses, the response 708 may not be published along with the responses 702-706 on the chat channel 600.

In some embodiments, the reviewing participant may request that the respective participant provide another response. In such case, the reviewing participant may select the option to reject the response. If the response 708 is rejected, then the respective participant who sent the response 708 may be prompted again to provide an updated collaborative message response. For example, the sending participant may receive a message on his or her chat channel 600 that indicates that the reviewing participant has rejected the response 708 and requests an updated response. Other participants outside of the sending participant may not receive any indication that the response 708 has been rejected. The sending participant can provide an updated response and the updated response may be provided on the review prompt 700. In some examples, the response 708 may be updated to reflect the updated response.

In some embodiments, the reviewing participant may select an option (not shown) to combine similar responses within 702-708 into a single response. For example, if collaborative message responses 702 and 704 provide the same response, then the reviewing participant may opt to combine the collaborative message responses 702 and 704 into a single collaborative message response. When released, the collaborative message responses 702 and 704 may be released as a single collaborative message response that identifies the responding participants who correspond to the collaborative message responses 702 and 704.

After the reviewing participant has reviewed the collaborative message responses 702-708 and made any desired changes, the reviewing participant may release the collaborative message responses 702-708. To release the collaborative message responses 702-708, the reviewing participant can select the release button 714. Once the collaborative message responses 702-708 are released, the collaborative message responses 702-708 are published onto the corresponding chat channel, such as the chat channel 600.

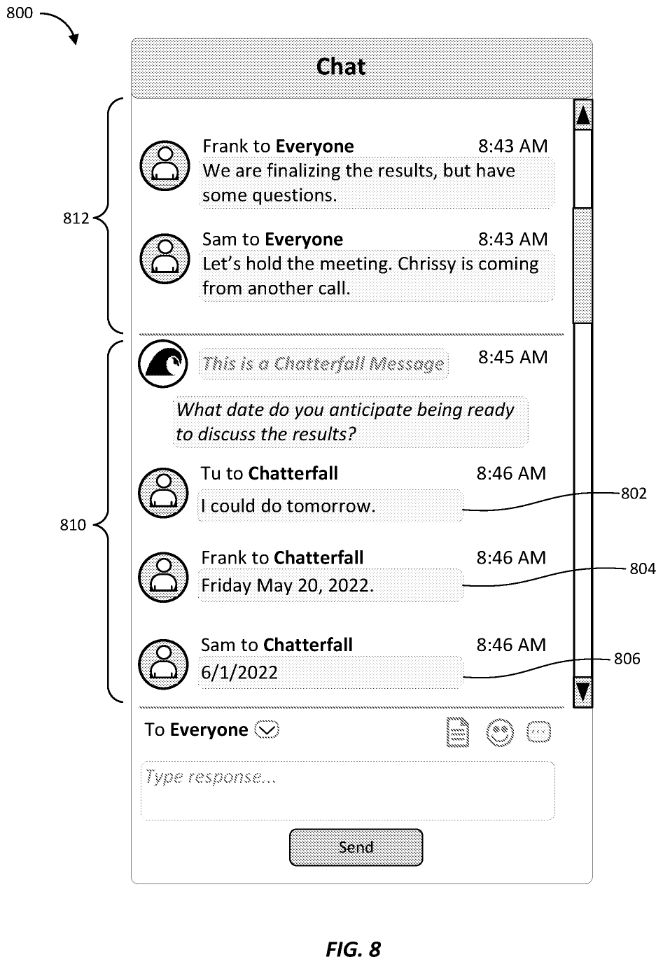

Referring now to FIG. 8, an example chat channel 800 with released collaborative message responses therein is provided, according to an embodiment herein. The example chat channel 800 may be the same or similar to the chat channel 500 or the chat channel 600. The following figures and related components, such as chat channel 800 of FIG. 8, will be described with respect to the systems shown in FIGS. 4-7, however, any suitable system according to this disclosure may be employed, such as those described in FIGS. 1-3.

The chat channel 800 illustrates an example chat channel in which collaborative message responses 802, 804, and 806 have been released. The collaborative message responses 802, 804, and 806 may be the same or similar to the collaborative message responses 702, 704, and 706. When the collaborative message responses 802, 804, and 806 publish on the chat channel 800 they may published simultaneously or in a group 810. That is, the responses 802, 804, and 806 may published together so that any normal chat messages 812 are not published in between the responses 802, 804, and 806. In that way, participants can see the responses 802, 804, and 806 together and none of the collaborative message responses 802, 804, or 806 get lost among the normal chat messages 812 within the chat channel 800 or vice versa. Moreover, because the responses 802, 804, and 806 published together the risk of other participant's perspectives skewing other's responses is minimalized. That is, participants can respond to the collaborative message request 616 without influence from seeing another participant's response. In the scenario in which a large quantity of message responses 802, 804, and 806 are receive via the chat channel 800, a user may be able to scroll through the group 810 to view the responses as desired.

In some embodiments, the group 810 of the collaborative message responses 802, 804, and 806 may provide a visual indication that they are part of the same collaborative message request. For example, the segment of the chat channel 800 that publishes the group 810 may change color or otherwise provide an indication that the collaborative message responses 802, 804, and 806 are different from the normal chat messages 812.

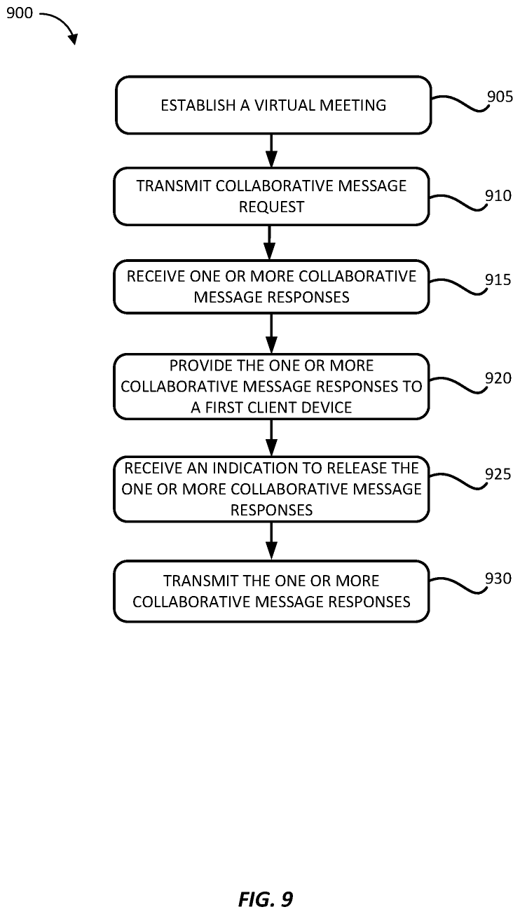

Referring now to FIG. 9, a flowchart of an example method 900 for providing collaborative chat messaging during a virtual meeting is provided. The description of the method 900 in FIG. 9 will be made with reference to FIGS. 3-8, however any suitable system according to this disclosure may be used, such as the example systems 100 and 200, shown in FIGS. 1 and 2.

The method 900 may include steps 905-930. At step 905, a virtual meeting may be established. The virtual meeting may be established by a video conference provider, such as the video conference provider 310. The virtual meeting may have a plurality of participants, for example, participants corresponding to client devices 340a-340m. Each of the plurality of participants may exchange one or more audio streams via the virtual meeting.

At step 910, a collaborative message request may be transmitted to the plurality of participants. For example, the collaborative message request 616 may be transmitted to the participants 404a-e during a virtual meeting. The collaborative message request 616 may be transmitted via a chat channel, such as the chat channel 600. The collaborative message request 616 may be transmitted to the virtual meeting participants via the video conference provider 310.

At step 915, one or more collaborative message responses may be received. For example, the collaborative message responses 702-708 may be received by the video conference provider 310 from a subset of the virtual meeting participants. Upon receiving the collaborative message responses, the video conference provider may provide the collaborative message responses to a first client device, at step 920. The first client device may correspond to a host, co-host, or one or more moderators of the virtual meeting, such as, for example, the host client device 330. In an example, the video conference provider 310 may transmit the collaborative message responses 702-708 to the host client device 330.

At step 925, the method 900 may include receiving from a first client device an indication to release the one or more collaborative message responses. For example, the video conference provider 310 may receive an indication from the host client device 330 to release the one or more collaborative message responses 702-708. As described above, prior to releasing the collaborative message responses, the host or moderator may edit or modify one or more of the collaborative message responses. For example, the host may remove a collaborative message response from the group of collaborative message responses or may change the format or language of one of the collaborative message responses. In such an example, the method 900 may include receiving, from the first client device, a rejection of a collaborative message response from a second client device. The one or more collaborative message responses may have included the collaborative message response from the second client device.

In some embodiments, after a collaborative message response is rejected, a responding participant may be able to submit a second collaborative message response. For example, the method may include transmitting, to the second client device, a request to submit a second collaborative message response based on the rejection of the collaborative message response from the second client device, receiving, from the second client device, the second collaborative message response, and transmitting the second collaborative message response to the plurality of participants as part of the one or more collaborative message responses.

After the video conference provider receives the indication to release the one or more collaborative message responses, the one or more collaborative message responses may be transmitted to the plurality of participants, at step 930. For example, the video conference provider 310 may transmit the one or more collaborative message responses 802-808 to the meeting participants via a chat channel 800. As described above, the collaborative message responses 802-808 may be transmitted via the chat channel 800 in a manner that keeps the collaborative message responses 802-808 together on the chat channel 800. For example, the collaborative message responses 802-808 may be transmitted simultaneously by the video conference provider 310.

In some embodiments, the one or more collaborative message responses may be provided to the first client device at a first time and the one or more collaborative message responses may be transmitted to the plurality of participants at a second time. The second time may occur after the first time. For example, the second time may be a time after the first client device receives the one or more collaborative message responses from a majority of the plurality of participants.

In an example embodiment, the method 900 may further include determining a response time period for the collaborative message request, determining an expiration of the response time period, and transmitting the one or more collaborative message responses to the plurality of participants based on the expiration of the response time period. Optionally, the expiration of the response time period may be established by the second time.

It should be appreciated that the specific steps illustrated in FIG. 9 provide a particular method of providing collaborative chat messaging, according to an embodiment of the present invention. Other sequences of steps may also be performed according to alternative embodiments. For example, alternative embodiments of the present invention may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize many variations, modifications, and alternatives.

The examples and embodiments described herein are for illustrative purposes only. Various modifications or changes in light thereof will be apparent to persons skilled in the art. These are to be included within the spirit and purview of this application, and the scope of the appended claims, which follow.

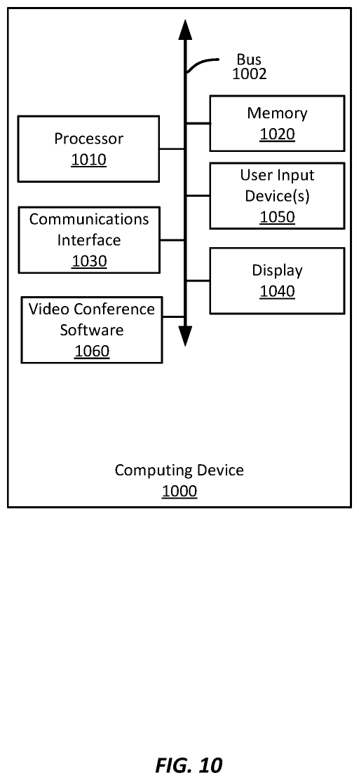

Referring now to FIG. 10, FIG. 10 shows an example computing device 1000 suitable for use in example systems or methods for providing collaborative chat messaging during a virtual meeting. The example computing device 1000 includes a processor 1010 which is in communication with the memory 1020 and other components of the computing device 1000 using one or more communications buses 1002. The processor 1010 is configured to execute processor-executable instructions stored in the memory 1020 to perform one or more methods for providing collaborative chat messaging during a virtual meeting, such as part or all of the example method 900, described above with respect to FIG. 9. The computing device, in this example, also includes one or more user input devices 1050, such as a keyboard, mouse, touchscreen, video input device (e.g., one or more cameras), microphone, etc., to accept user input. The computing device 1000 also includes a display 1040 to provide visual output to a user.

The computing device 1000 also includes a communications interface 1030. In some examples, the communications interface 1030 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof Illustrative examples are discussed above in the Detailed Description, which provides further description. Advantages offered by various examples may be further understood by examining this specification

As used below, any reference to a series of examples is to be understood as a reference to each of those examples disjunctively (e.g., “Examples 1-4” is to be understood as “Examples 1, 2, 3, or 4”).

Example 1 is a system comprising: a non-transitory computer-readable medium; a communications interface; and a processor communicatively coupled to the non-transitory computer-readable medium and the communications interface, the processor configured to execute processor-executable instructions stored in the non-transitory computer-readable medium to: establish a virtual meeting having a plurality of participants, each participant of the plurality of participants exchanging one or more audio streams via the virtual meeting; transmit a collaborative message request to the plurality of participants; receive one or more collaborative message responses from each participant of a subset of the plurality of participants; provide, to a first client device, the one or more collaborative message responses; receive, from the first client device, an indication to release the one or more collaborative message responses; and transmit, to the plurality of participants, the one or more collaborative message responses.

Example 2 is the system of any previous or subsequent example, wherein, prior to executing the instructions to receive, from the first client device, the indication to release the one or more collaborative message response, the instructions further cause the processor to execute further processor-executable instructions stored in the non-transitory computer-readable medium to: cache the one or more collaborative message responses.

Example 3 is the system of any previous or subsequent example, wherein the processor is configured to execute further processor-executable instructions stored in the non-transitory computer-readable medium to: receive, from the first client device, an indication to anonymize the collaborative message responses.

Example 4 is the system of any previous or subsequent example, wherein the processor is configured to execute further processor-executable instructions stored in the non-transitory computer-readable medium to: anonymize the one or more collaborative message responses when received from each of the at least the subset of the plurality of participants.

Example 5 is the system of any previous or subsequent example, wherein the processor is configured to execute further processor-executable instructions stored in the non-transitory computer-readable medium to: establish a chat channel during the virtual meeting, wherein the collaborative chat messages are transmitted to the plurality of participants via the chat channel.

Example 6 is the system of any previous or subsequent example, wherein the processor is configured to execute further processor-executable instructions stored in the non-transitory computer-readable medium to: receive, from the first client device, a modification to the one or more collaborative message responses prior to transmitting the one or more collaborative message responses to the plurality of participants.

Example 7 is the system of any previous or subsequent example, wherein the first client device corresponds to at least one of a host of the virtual meeting or a moderator of the virtual meeting.

Example 8 is a method comprising: establishing, by a video conference provider, a virtual meeting having a plurality of participants, each participant of the plurality of participants exchanging one or more audio streams via the virtual meeting; transmitting, by the video conference provider, a collaborative message request to the plurality of participants; receiving, by the video conference provider, one or more collaborative message responses from each participant of a subset of the plurality of participants; providing, by the video conference provider, the one or more collaborative message responses to a first client device; receiving, by the video conference provider, from the first client device, an indication to release the one or more collaborative message responses; and transmitting, by the video conference provider, the one or more collaborative message responses to the plurality of participants.

Example 9 is the method of any previous or subsequent example, wherein: providing, by the video conference provider, the one or more collaborative message responses to the first client device comprises providing the one or more collaborative message responses to the first client device at a first time; transmitting, by the video conference provider, the one or more collaborative message responses to the plurality of participants comprises transmitting the one or more collaborative message responses to the plurality of participants at a second time; and the second time occurs after the first time.

Example 10 is the method of any previous or subsequent example, wherein the second time is a time after the first client device receives the one or more collaborative message responses from a majority of the plurality of participants.

Example 11 is the method of any previous or subsequent example, the method further comprises: determining a response time period for the collaborative message request; determining an expiration of the response time period; and transmitting the one or more collaborative message responses to the plurality of participants based on the expiration of the response time period.

Example 12 is the method of any previous or subsequent example, wherein the expiration of the response time period is established by the second time.

Example 13 is the method of any previous or subsequent example, the method further comprising: receiving, from the first client device, a rejection of a collaborative message response from a second client device, wherein the one or more collaborative message responses comprises the collaborative message response from the second client device.

Example 14 is the method of any previous or subsequent example, the method further comprising: transmitting, to the second client device, a request to submit a second collaborative message response based on the rejection of the collaborative message response from the second client device; receiving, from the second client device, the second collaborative message response; and transmitting the second collaborative message response to the plurality of participants as part of the one or more collaborative message responses.

Example 15 is a non-transitory computer-readable medium comprising processor-executable instructions configured to cause one or more processors to: establish a virtual meeting having a plurality of participants, each participant of the plurality of participants exchanging one or more audio streams via the virtual meeting; transmit a collaborative message request to the plurality of participants; receive one or more collaborative message responses from each participant of a subset of the plurality of participants; provide, to a first client device, the one or more collaborative message responses; receive, from the first client device, an indication to release the one or more collaborative message responses; and transmit, to the plurality of participants, the one or more collaborative message responses.

Example 16 is the non-transitory computer-readable medium of any previous or subsequent example, wherein the instructions to transmit, to the plurality of participants, the one or more collaborative message responses further causes the processor to execute further processor-executable instructions stored in the non-transitory computer-readable medium to: transmit, to the plurality of participants, the one or more collaborative message responses via a chat channel.

Example 17 is the non-transitory computer-readable medium of any previous or subsequent example, wherein the one or more collaborative message responses are transmitted simultaneously via the chat channel to each of the plurality of participants.

Example 18 is the non-transitory computer-readable medium of any previous or subsequent example, wherein the processor is configured to execute further processor-executable instructions stored in the non-transitory computer-readable medium to: provide an indication within the chat channel that the one or more collaborative message response are part of a collaborative message.

Example 19 is the non-transitory computer-readable medium of any previous or subsequent example, wherein the processor is configured to execute further processor-executable instructions stored in the non-transitory computer-readable medium to: receive, from a second client device, a request to transmit a collaborative message response anonymously; and anonymize the collaborative message response from the second client device prior to transmitting the collaborative message response as part of the one or more collaborative message responses to the first client device.

Example 20 is the non-transitory computer-readable medium of any previous or subsequent example, wherein the instructions to transmit, to the plurality of participants, the one or more collaborative message responses further causes the processor to execute further processor-executable instructions stored in the non-transitory computer-readable medium to: associate each of the one or more collaborative message responses with a participant of the plurality of participants; and transmit, to the plurality of participants, an identification of the participant associated with each of the one or more collaborative message responses.

1. A system comprising:
a non-transitory computer-readable medium;
a communications interface; and
a processor communicatively coupled to the non-transitory computer-readable medium and the communications interface, the processor configured to execute processor-executable instructions stored in the non-transitory computer-readable medium to:
establish a virtual meeting having a plurality of participants, each participant of the plurality of participants exchanging one or more audio streams via the virtual meeting;
transmit a collaborative message request to the plurality of participants;
receive one or more collaborative message responses from each participant of a subset of the plurality of participants;
provide, to a first client device, the one or more collaborative message responses;
receive, from the first client device, a modification to the one or more collaborative message responses prior to transmitting the one or more collaborative message responses to the plurality of participants;
receive, from the first client device, an indication to release the one or more collaborative message responses; and
transmit, to the plurality of participants, the one or more collaborative message responses.

2. The system of claim 1, wherein, prior to executing the instructions to receive, from the first client device, the indication to release the one or more collaborative message response, the instructions further cause the processor to execute further processor-executable instructions stored in the non-transitory computer-readable medium to:
cache the one or more collaborative message responses.

3. The system of claim 1, wherein the processor is configured to execute further processor-executable instructions stored in the non-transitory computer-readable medium to:
receive, from the first client device, an indication to anonymize the collaborative message responses.

4. The system of claim 3, wherein the processor is configured to execute further processor-executable instructions stored in the non-transitory computer-readable medium to:
anonymize the one or more collaborative message responses when received from each of the at least the subset of the plurality of participants.

5. The system of claim 1, wherein the processor is configured to execute further processor-executable instructions stored in the non-transitory computer-readable medium to:
establish a chat channel during the virtual meeting, wherein the collaborative message responses are transmitted to the plurality of participants via the chat channel.

6. (canceled)

7. The system of claim 5, wherein the first client device corresponds to at least one of a host of the virtual meeting or a moderator of the virtual meeting.

8. A method comprising:
establishing, by a video conference provider, a virtual meeting having a plurality of participants, each participant of the plurality of participants exchanging one or more audio streams via the virtual meeting;
transmitting, by the video conference provider, a collaborative message request to the plurality of participants;
receiving, by the video conference provider, one or more collaborative message responses from each participant of a subset of the plurality of participants;
providing, by the video conference provider, the one or more collaborative message responses to a first client device;
receiving, from the first client device, a modification to the one or more collaborative message responses prior to transmitting the one or more collaborative message responses to the plurality of participants;
receiving, by the video conference provider, from the first client device, an indication to release the one or more collaborative message responses; and
transmitting, by the video conference provider, the one or more collaborative message responses to the plurality of participants.

9. The method of claim 8, wherein:
providing, by the video conference provider, the one or more collaborative message responses to the first client device comprises providing the one or more collaborative message responses to the first client device at a first time;
transmitting, by the video conference provider, the one or more collaborative message responses to the plurality of participants comprises transmitting the one or more collaborative message responses to the plurality of participants at a second time; and
the second time occurs after the first time.

10. The method of claim 9, wherein the second time is a time after the first client device receives the one or more collaborative message responses from a majority of the plurality of participants.

11. The method of claim 9, the method further comprises:
determining a response time period for the collaborative message request;
determining an expiration of the response time period; and
transmitting the one or more collaborative message responses to the plurality of participants based on the expiration of the response time period.

12. The method of claim 11, wherein the expiration of the response time period is established by the second time.

13. The method of claim 8, the method further comprising:
receiving, from the first client device, a rejection of a collaborative message response from a second client device, wherein the one or more collaborative message responses comprises the collaborative message response from the second client device.

14. The method of claim 13, the method further comprising:
transmitting, to the second client device, a request to submit a second collaborative message response based on the rejection of the collaborative message response from the second client device;
receiving, from the second client device, the second collaborative message response; and
transmitting the second collaborative message response to the plurality of participants as part of the one or more collaborative message responses.

15. A non-transitory computer-readable medium comprising processor-executable instructions configured to cause one or more processors to:
establish a virtual meeting having a plurality of participants, each participant of the plurality of participants exchanging one or more audio streams via the virtual meeting;
transmit a collaborative message request to the plurality of participants;
receive one or more collaborative message responses from each participant of a subset of the plurality of participants;
provide, to a first client device, the one or more collaborative message responses;
receive, from the first client device, a modification to the one or more collaborative message responses prior to transmitting the one or more collaborative message responses to the plurality of participants;
receive, from the first client device, an indication to release the one or more collaborative message responses; and
transmit, to the plurality of participants, the one or more collaborative message responses.

16. The non-transitory computer-readable medium of claim 15, wherein the instructions to transmit, to the plurality of participants, the one or more collaborative message responses further causes the processor to execute further processor-executable instructions stored in the non-transitory computer-readable medium to:
transmit, to the plurality of participants, the one or more collaborative message responses via a chat channel.

17. The non-transitory computer-readable medium of claim 16, wherein the one or more collaborative message responses are transmitted simultaneously via the chat channel to each of the plurality of participants.

18. The non-transitory computer-readable medium of claim 16, wherein the processor is configured to execute further processor-executable instructions stored in the non-transitory computer-readable medium to:
provide an indication within the chat channel that the one or more collaborative message response are part of a collaborative message.

19. The non-transitory computer-readable medium of claim 15, wherein the processor is configured to execute further processor-executable instructions stored in the non-transitory computer-readable medium to:
receive, from a second client device, a request to transmit a collaborative message response anonymously; and
anonymize the collaborative message response from the second client device prior to transmitting the collaborative message response as part of the one or more collaborative message responses to the first client device.

20. The non-transitory computer-readable medium of claim 15, wherein the instructions to transmit, to the plurality of participants, the one or more collaborative message responses further causes the processor to execute further processor-executable instructions stored in the non-transitory computer-readable medium to:
associate each of the one or more collaborative message responses with a participant of the plurality of participants; and
transmit, to the plurality of participants, an identification of the participant associated with each of the one or more collaborative message responses.
